(19) United States
(12) Patent Application Publication
(10) Pub. No.: US 2014/0345147 A1
(43) Pub. Date: Nov. 27, 2014

(54) EXCHANGE MECHANISM FOR KNIFE

(71) Applicants: Spencer Frazer, Lynnwood, WA (US); Beren McKay, Lynnwood, WA (US)

(72) Inventors: Spencer Frazer, Lynnwood, WA (US); Beren McKay, Lynnwood, WA (US)

(21) Appl. No.: 14/214,766

(22) Filed: Mar. 15, 2014

Related U.S. Application Data
(60) Provisional application No. 61/802,007, filed on Mar. 15, 2013.

(51) Int. Cl. B26B 5/00

(52) U.S. Cl. CPC B26B 5/00
USPC 30/336

(57) ABSTRACT

An exchange mechanism for a knife is disclosed. In some embodiments, a knife having a blade exchange mechanism includes a blade having a cutting edge and a blade tang, wherein the blade tang has an opening defining a hole to receive a pin, and a handle having an opening to receive the blade tang, the handle having a spring loaded bar coupled to the handle on a pivot, the spring loaded bar having a pin to be received in the tang opening defining a hole to exchangeably lock the blade in the handle.

### RELATED APPLICATIONS

This application claims the benefit of U.S. Provisional Application No. 61/802,007, filed Mar. 15, 2013.

### BACKGROUND

Replaceable blade knives are used in utility knives, carpet cutting knives, XACTO knives, etc. Currently, replaceable blade knives provide only limited information about the state of a locking or attaching mechanism of the replaceable blade within a knife handle. Additionally, current replaceable blade knives provide limited if any information while the knife is being used of a changing condition of the locking or attaching mechanism of the replaceable blade.

### SUMMARY

Accordingly, an exchange mechanism for a knife is described below in the Detailed Description. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a plan view of an exchange mechanism for a knife illustrating a detachable blade in a partially inserted position.

FIG. 2 is a plan view of the exchange mechanism for the knife in FIG. 1 illustrating a detachable blade in an inserted position but with a locking mechanism depressed into an unlocked state.

FIG. 3 is a section view of the exchange mechanism for the knife in FIG. 2 illustrating a detachable blade in an inserted position with a locking mechanism protruding laterally from the knife handle.

FIG. 4 is a section view of another embodiment exchange mechanism illustrating a detachable blade in a partially inserted position with a locking mechanism protruding laterally from the knife handle.

FIG. 5 is a section view of the exchange mechanism in FIG. 4 illustrating a detachable blade in an inserted position with a locking mechanism in equilibrium while in the locked position.

FIG. 6 is a plan view of the exchange mechanism for the knife in FIG. 1 illustrating a detachable blade in an inserted position and a locking mechanism in a locked position.

FIG. 7 is a section view of the exchange mechanism for the knife in FIG. 6 illustrating a detachable blade in an inserted position with a locking mechanism in a locked position.

FIG. 8 is a section view of the exchange mechanism illustrating a ramped pin and a detachable blade in an inserted position with a locking mechanism in a locked position.

FIG. 9 is a section view of a tang stabilizing arrangement between a blade tang and a knife handle.

FIG. 10 is a section view of a tang stabilizing arrangement between a blade tang and a knife handle.

FIG. 11 is a section view of a tang stabilizing arrangement between a blade tang and a knife handle.

FIG. 12 is a section view of a tang stabilizing arrangement between a blade tang and a knife handle.

### DETAILED DESCRIPTION

A disclosed knife with an exchange mechanism may include a spring-loaded bar with a pin, where the spring-loaded bar can rock up and down in the pin can travel through two liners in handle and a blade tang allowing blades to be exchanged or locked in position. In this embodiment, this approach can increase safety. For example, the disclosed mechanism is designed such that it is obvious when a blade or tool is not positively and securely locked into a handle. When the disclosed knife is in operation in a user's hand, the users hand is securely over a locking mechanism thereby ensuring it will stay locked while at the same time if it becomes unlocked the user has tactile feedback that the blade may be unlocked. I disclosed knife may also include a viewable channel over the pin and tang intersection, allowing a user to see when the tang is in place and also when the pin is fed through it securely.

A disclosed knife includes a pin passes through the liners in the tang, liners and the handle and tang with holes or cutouts that all lineup such that the pin can pass through them. In this way, the pin is attached to a lever arm that contains a spring which biases the lever arm, and therefore the pin, such that the pin is passing through the liners in the tang in its equilibrium position.

Current approaches having interchangeable knife blades or tools do not have a readily available way to detect the blades or tools are positively a disclosed knife in place. Makes it more obvious if the lock is positively engaged. For example, if the tang is not question far enough into the handle in either the locking mechanism will be protruding uncomfortably into the users hand or the necked down portion of the tang will be protruding from the handle.

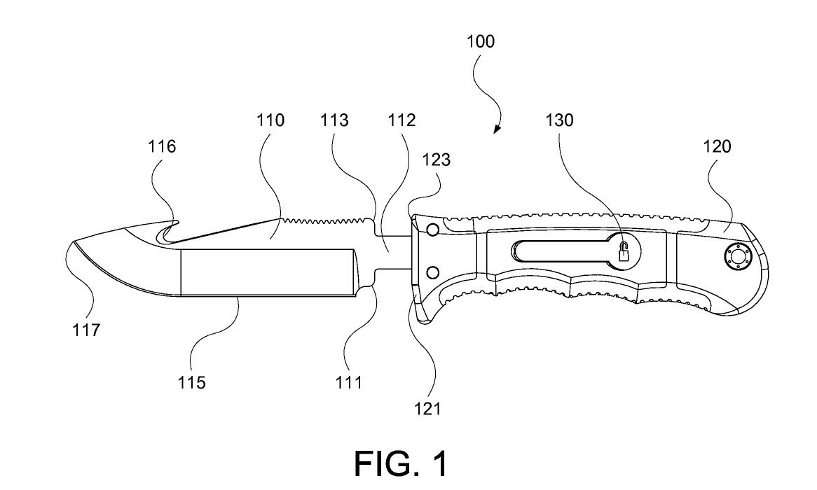

The disclosed knife allows for a safer use of an interchangeable blade tool device. Some example applications of this knife would be a chefs knife kit where the user has one handle with all of the different chef knife blades all in one compact kit, a hunting knife kit which could include a combination of both knife blades and tools such as skinning boning knives and a wood saw, a car toolkit with various wrenches a file various screwdrivers, or multiple other embodiments within the principles of this disclosure. We now turn to FIG. 1 to discuss the disclosed knife.

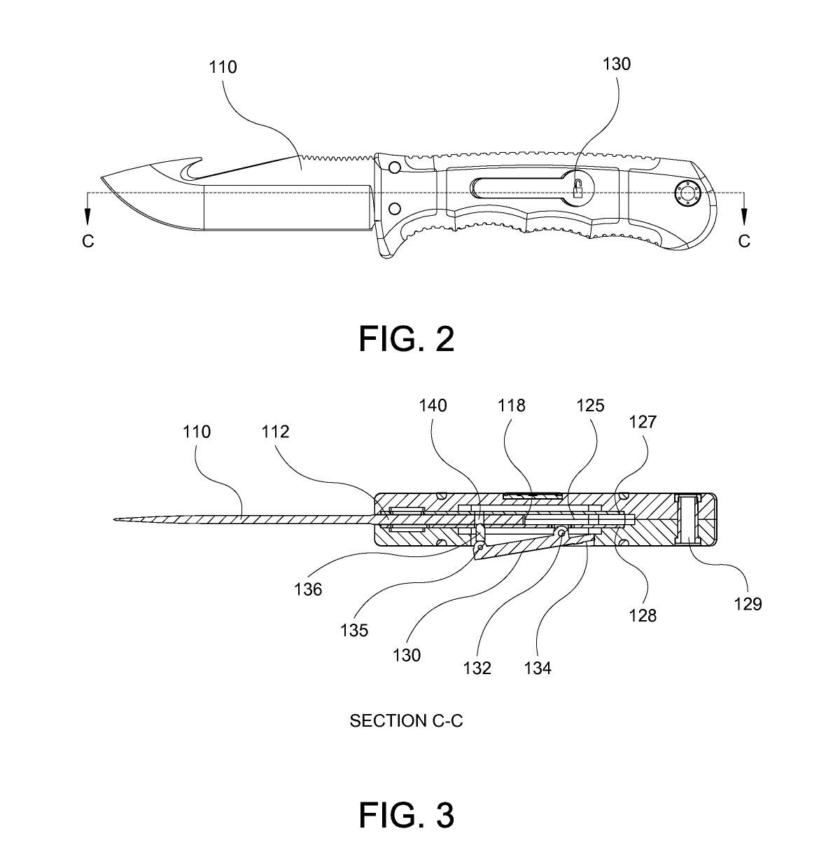

FIG. 1 is a plan view of an exchange mechanism for a knife 100 illustrating a detachable blade in a partially inserted position. Knife 100 includes handle portion 120 and blade portion 110. Blade portion 110 includes tang 112, rear blade base 113, front blade base 111, blade edge 115, blade point 117, and a gut hook 116. Handle 120 includes spring-loaded bar 130, back base 123, and front base 121. FIG. 1 shows an exchangeable blade in a partially detached or partially inserted position and spring-loaded bar depressed so as to not lock the blade tang 112. We now turn to FIGS. 2 and 3 to describe one embodiment locking mechanism.

FIG. 2 is a plan view of the exchange mechanism for the knife in FIG. 1 illustrating a detachable blade in an inserted position but with a locking mechanism depressed into an unlocked state. FIG. 3 is a section view of the exchange mechanism for the knife in FIG. 2 illustrating a detachable blade in an inserted position with a locking mechanism protruding laterally from the knife handle. Referring to FIG. 3, blade 110 and blade tang 112 into the knife handle and spring-loaded bar 130 is depressed so that pin 136 is not obstructing blade tang 112. In FIG. 3, spring-loaded bar 130 includes a pivot 132, a contact point 134, a pin pivot 135 and a pin 136. Tang 112 includes a hole 140 to receive pin 136 and lock blade 110 into the knife handle.

The knife handle also includes (not numbered, but shown near the handle top where the blade tang is inserted) one or more “living springs” to secure the blade into the handle without a positive lock. For example, the blade tang may have indentations on either side aligning with one or more living springs. In this way, when the tang 112 is inserted into the handle, once the indentations are aligned with the living springs, the living springs will extend into the blade tang and partially secure the blade in place in the handle. At this point with the blade tang in the fully inserted position, the pin 136 can be inserted through hole 140 of tang 112 and can positively lock the blade within the handle.

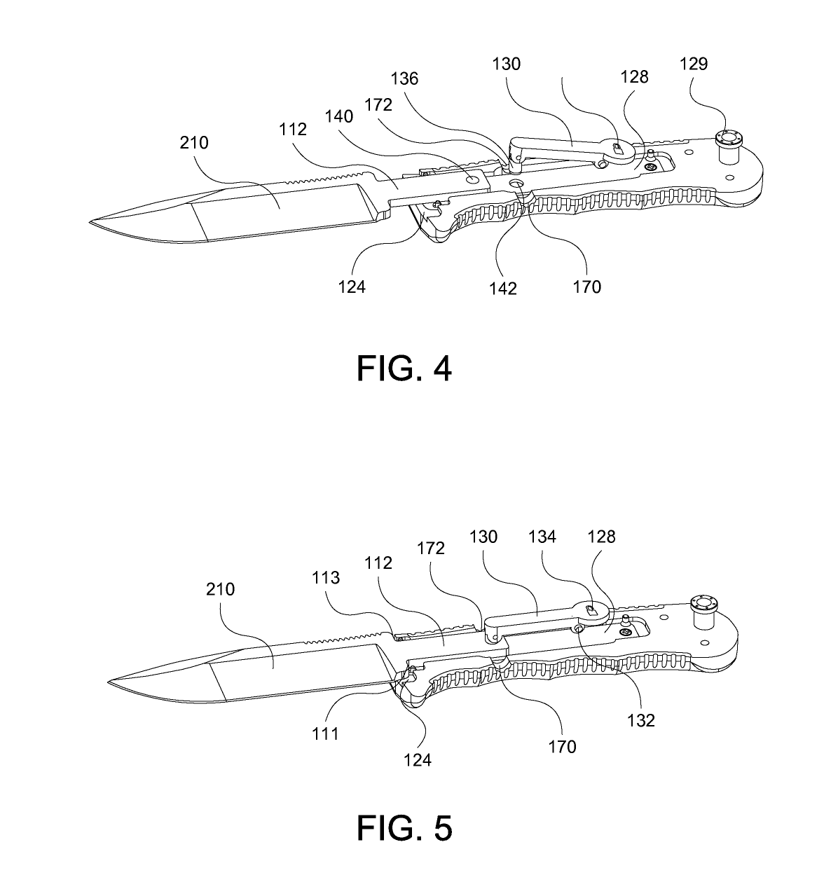

FIGS. 4 and 5 are section views that illustrate another embodiment locking mechanism. FIG. 4 is a section view of another embodiment exchange mechanism illustrating a detachable blade in a partially inserted position with a locking mechanism protruding laterally from the knife handle. FIG. 5 is a section view of the exchange mechanism in FIG. 4 illustrating a detachable blade in an inserted position with a locking mechanism in equilibrium while in the locked position. FIG. 4 illustrates blade 210 in a partially inserted position while FIG. 5 illustrates the blade fully seated within the handle and the locking mechanism in a locked position. In this embodiment, the blade bases 113 and 111 insert into a cavity 124 within the handle. Additionally, holes 170 and 172 allow a user to see the blade tang within the handle and also to see if the pin of the spring-loaded bar is placed through the tang hole 140.

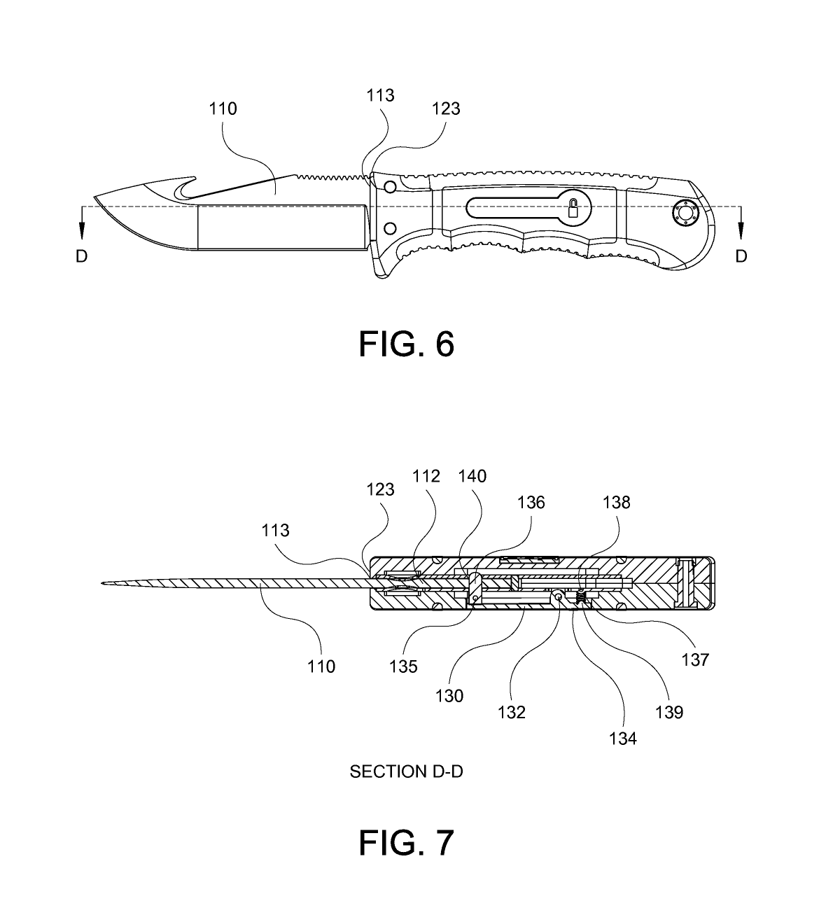

FIG. 6 is a plan view of the exchange mechanism for the knife in FIG. 1 illustrating a detachable blade in an inserted position and a locking mechanism in a locked position. FIG. 7 is a section view of the exchange mechanism for the knife in FIG. 6 illustrating a detachable blade in an inserted position with a locking mechanism in a locked position. With reference to FIG. 7, the blade 110 is fully inserted into handle and spring 139 is applying a closing force on spring-loaded bar 130 such that pin 136 is maintained through hole 140. Also illustrated in FIG. 7, the spring of the handle is engaging the tang near the end of the handle that receives the blade 110. In this embodiment, when the exchange mechanism is locking a knife within the handle, the spring-loaded bar is flush with the handle and feels like a normal operating position to a knife user.

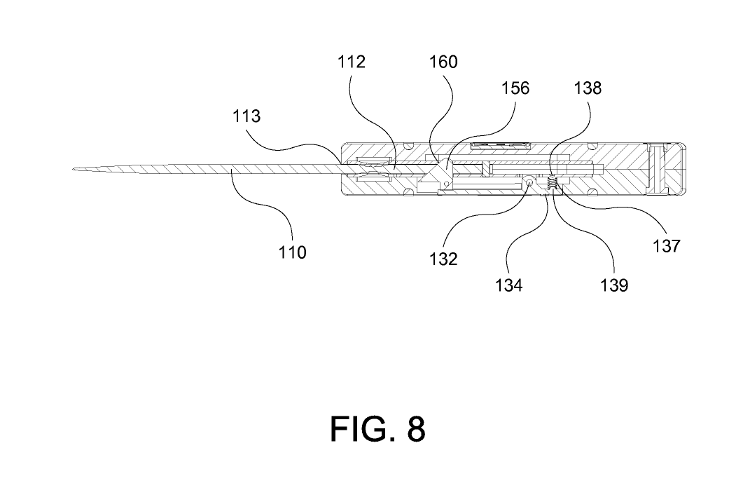

FIG. 8 is a section view of the exchange mechanism illustrating a ramped pin and a detachable blade in an inserted position with a locking mechanism in a locked position. In FIG. 8, the blade 110 is fully inserted into handle and spring 139 is applying a closing force on spring-loaded bar 130 such that ramped pin 156 is maintained through hole 160. In this embodiment, the ramped pin 156 allows the blade 110 to be inserted into the handle without otherwise manually releasing the spring loaded bar. That is, the ramp of ramped pin 156 receives the end of the blade tang and the force of the blade being inserted into the handle pushes on the ramped pin 156 and allows the blade tang to be fully inserted where ramped pin 156 will then by spring force extend through hole 160, locking the blade within the handle.

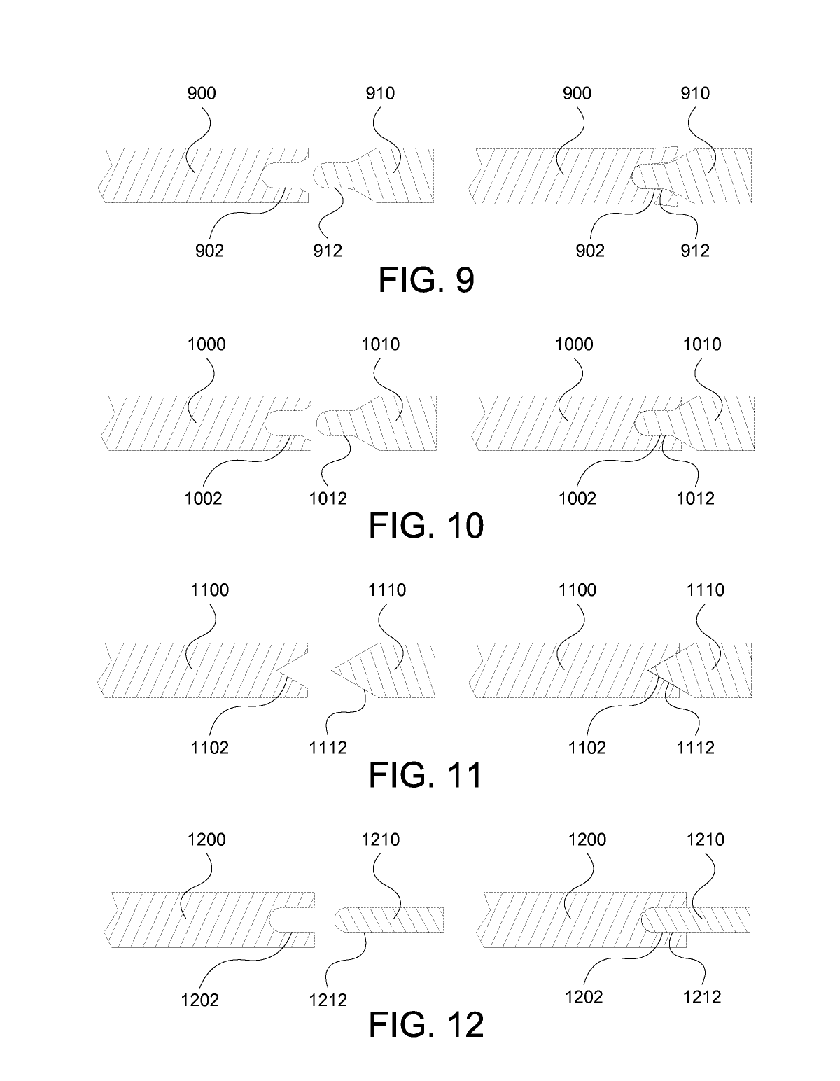

FIGS. 9-12 are section views of a tang stabilizing arrangement between a blade tang and a knife handle. These embodiments provide additional stabilization of a blade that is held in a handle with an exchange mechanism as disclosed herein. For example, the symmetric mating surfaces of the tang and handle in FIGS. 9-12 reduce the ability of the blade to move in relation to the handle by restricting relative rotation motion in the plane of the figure between the tang and the handle. FIG. 9 depicts a similar cross section as FIG. 10, but illustrates the mating contour of the blade or handle may be deformed when the complementary mating surface is inserted into the opening. In some embodiments the concave portion may be on the blade tang and the convex portion within the handle while in other embodiments the convex portion may be on the blade tang and the concave portion within the handle, but other embodiments are not so limited.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A knife having a blade exchange mechanism, comprising:
a blade having a cutting edge and a blade tang, wherein the blade tang has an opening defining a hole to receive a pin; and
a handle having an opening to receive the blade tang, the handle having a spring loaded bar coupled to the handle on a pivot, the spring loaded bar having a pin to be received in the tang opening defining a hole to exchangeably lock the blade in the handle.
